(19) United States
(12) Patent Application Publication
(10) Pub. No.: US 2010/0082482 A1
(43) Pub. Date: Apr. 1, 2010

(54) Systems and Methods for Aggregating and Donating Dormant Prepaid Card Amounts

(76) Inventor: Theodore F. VanDeburg, Denver, CO (US)

Correspondence Address: SUTHERLAND ASBILL & BRENNAN LLP, 999 PEACHTREE STREET, N.E., ATLANTA, GA, 30309, US

(21) Appl. No.: 12/239,436

(22) Filed: Sep. 26, 2008

(51) Int. Cl. G06Q 40/00

(52) U.S. Cl. 705/42; 705/39

(57) ABSTRACT

Embodiments of the invention relate to systems and methods for aggregating and donating dormant prepaid card amounts. In one embodiment, a method of donating a monetary amount associated with a dormant prepaid card can comprise determining an end of life associated with at least one of a plurality of prepaid cards. The method can also comprise receiving an indication to donate a portion of a respective monetary amount associated with the at least one of the plurality of prepaid cards. In addition, the method can comprise facilitating transfer of monetary funds corresponding to any donated monetary amount to at least one account associated with at least one donation recipient.

### TECHNICAL FIELD

The invention relates generally to stored value cards, and more particularly to systems and methods for aggregating and donating dormant prepaid card amounts.

### BACKGROUND OF THE INVENTION

Prepaid cards, also known as stored value cards or gift cards, have been provided by merchants to consumers to use as payment instruments for a variety of goods and services. In some instances, prepaid cards can have predetermined monetary amounts stored on or otherwise associated with the cards. In other instances, the monetary amount on the card can be recharged or otherwise replenished or added to. For some types of prepaid cards with predetermined monetary amounts, the monetary amount may be subject to an expiration date. That is, once a prepaid card is activated for payment by a consumer or merchant, the prepaid card may expire, whether the predetermined monetary amount on the card is spent, within a certain predefined amount of time, such as 3 or 5 years from the activation date. In most instances, the merchant expects consumers to spend or otherwise deplete the stored monetary amount on goods and services provided by the merchant. However, in some instances, unspent monetary amounts may remain on or may remain associated with the cards. For merchants administering numerous prepaid cards in prepaid card programs, the accumulation of unspent monetary amounts on prepaid cards can be problematic and expensive to administer.

For example, in some instances, unspent monetary amounts on prepaid cards can revert, or escheat, to the state or government. Certain states may have laws or rules governing the circumstances when unclaimed property, such as unspent monetary amounts on prepaid cards, can be taken by the state or government. In these instances, the merchant may lose money in issuing, administering, and accounting for the prepaid cards, and the unspent monetary amount on such cards may be taken by the state or government. In other instances, the merchant may claim the unspent monetary amounts as revenue in a practice called “breakage”, and the value of the prepaid cards can be removed from the merchant's books. In these instances, the merchants may be subject to certain accounting rules, which may yet add to the merchant's cost in administering, and accounting for the prepaid card.

Therefore a need exists for systems and methods for aggregating and donating dormant prepaid card amounts.

A further need exists for systems and methods of donating a monetary amount associated with a dormant prepaid card.

A further need exists for systems and methods of donating a monetary amount associated with a plurality of dormant prepaid cards.

### SUMMARY OF THE INVENTION

Embodiments of the invention can provide some or all of the above needs. Certain embodiments of the invention can provide systems and methods for aggregating and donating dormant prepaid card amounts. Certain embodiments can provide systems and methods of donating a monetary amount associated with a dormant prepaid card. Certain embodiments can provide systems and methods of donating a monetary amount associated with a plurality of dormant prepaid cards. In one embodiment, a method for donating a monetary amount associated with a dormant prepaid card can include determining an end of life associated with at least one of a plurality of prepaid cards. In addition, the method can include receiving an indication to donate a portion of a respective monetary amount associated with the at least one of the plurality of prepaid cards. Furthermore, the method can include facilitating transfer of monetary funds corresponding to any donated monetary amount to at least one account associated with at least one donation recipient.

In another embodiment, a system for donating a monetary amount associated with a dormant prepaid card can be provided. The system can include a processor comprising a computer-readable medium with a set of instructions operable to determine an end of life associated with at least one of a plurality of prepaid cards. The set of instructions can be further operable to receive an indication to donate a portion of a respective monetary amount associated with the at least one of the plurality of prepaid cards. In addition, the set of instructions can be further operable to facilitate transfer of monetary funds corresponding to any donated monetary amount to at least one account associated with at least one donation recipient.

In yet another embodiment, a method for aggregating and donating monetary amounts associated with a plurality of dormant prepaid cards can be provided. The method can include determining an end of life associated with each of a plurality of prepaid cards. Furthermore, the method can include receiving a plurality of indications to donate a portion of respective monetary amounts associated with at least some of the plurality of prepaid cards. In addition, the method can include aggregating the respective donated monetary amounts. Further, the method can include facilitating transfer of monetary funds corresponding to any donated monetary amounts to at least one account associated with at least one donation recipient. Moreover, the method can include transmitting a notification to a consumer associated with at least one of the plurality of prepaid cards or to at least one donation recipient that a donation has been facilitated.

In another embodiment, a system for aggregating and donating monetary amounts associated with a plurality of dormant prepaid cards can include a processor comprising a computer-readable medium with a set of instructions operable to can include determining an end of life associated with each of a plurality of prepaid cards. The set of instructions can be further operable to receive a plurality of indications to donate a portion of respective monetary amounts associated with at least some of the plurality of prepaid cards. In addition, the set of instructions can be further operable to aggregate the respective donated monetary amounts. Further, the set of instructions can be further operable to facilitate transfer of monetary funds corresponding to any donated monetary amounts to at least one account associated with at least one donation recipient. Moreover, the set of instructions can be further operable to transmit a notification to a consumer associated with at least one of the plurality of prepaid cards or to at least one donation recipient that a donation has been facilitated.

In yet another embodiment, a method of donating a monetary amount associated with a dormant prepaid card can include inputting information associated with at least one prepaid card. The method can also include inputting an indication to donate a monetary amount associated with the at least one prepaid card. Further, the method can include inputting a selection of at least one donation recipient to donate the monetary amount to. Moreover, the method can include receiving an output confirming a donation to the at least one donation recipient has been received.

Other systems and processes according to various embodiments of the invention will become apparent with respect to the remainder of this document.

### BRIEF DESCRIPTION OF DRAWINGS

Having thus described embodiments of the invention in general terms, reference will now be made to the accompanying drawings, which are not drawn to scale, and wherein:

FIG. 1 illustrates an example functional block diagram of an example system, according to one embodiment of the invention;

FIG. 2 illustrates an example data flow of an example system and method, according to one embodiment of the invention

FIG. 3 illustrates an example flowchart of an example method, according to one embodiment of the invention;

FIG. 4 illustrates an example flowchart of an example method, according to one embodiment of the invention; and

FIG. 5 illustrates an example flowchart of an example method, according to one embodiment of the invention.

### DETAILED DESCRIPTION OF EMBODIMENTS OF THE INVENTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention. Like numbers refer to like elements throughout.

As used herein, the term “prepaid card” can refer to a gift card, a stored value card, a tangible medium, or an electronic or virtual-type instrument provided by a merchant, a retailer, a merchant bank, a financial institution, or any other type of entity. For example, a prepaid card can be a card with a predetermined monetary amount associated with the card. In another example, a prepaid card can be an electronic certificate with a predetermined monetary amount associated with the certificate.

As used herein, the term “end of life” can refer to an expiration date or time, or a passage of time from a certain date or time, or passage of time since the card was last used. In any instance, an end of life for a prepaid card describes the end of a predefined period of time when a consumer is likely to spend any monetary funds associated with the prepaid card, wherein afterwards, any unspent monetary funds remaining for the prepaid card can be paid to a government agency or otherwise paid to a merchant associated with the prepaid card.

Certain embodiments of the invention generally provide for systems and methods that donating a monetary amount associated with a dormant prepaid card. Such systems and methods can provide a selectable option to donate a monetary amount associated with a dormant prepaid card when a consumer uses or otherwise accesses a point of sale device, point of sale terminal, or website with a particular prepaid card. If the consumer desires to donate a monetary amount corresponding with some or all of the remaining funds for the dormant prepaid card, an indication can be transmitted to facilitate transfer of monetary funds corresponding to any donated monetary amount to at least one account associated with at least one donation recipient. In at least one embodiment, one or more monetary amounts can be aggregated from multiple dormant prepaid cards associated with one or more consumers, and the aggregated monetary amounts can be transferred to at least one account associated with at least one donation recipient.

Certain embodiments of systems and methods described herein can provide a competitive feature when marketing such prepaid cards to consumers. Because certain embodiments can be implemented at a point of sale or via a website, merchants can offer to prepaid card customers certain services related to these systems and methods, thus providing unique benefits to consumers as well as merchants.

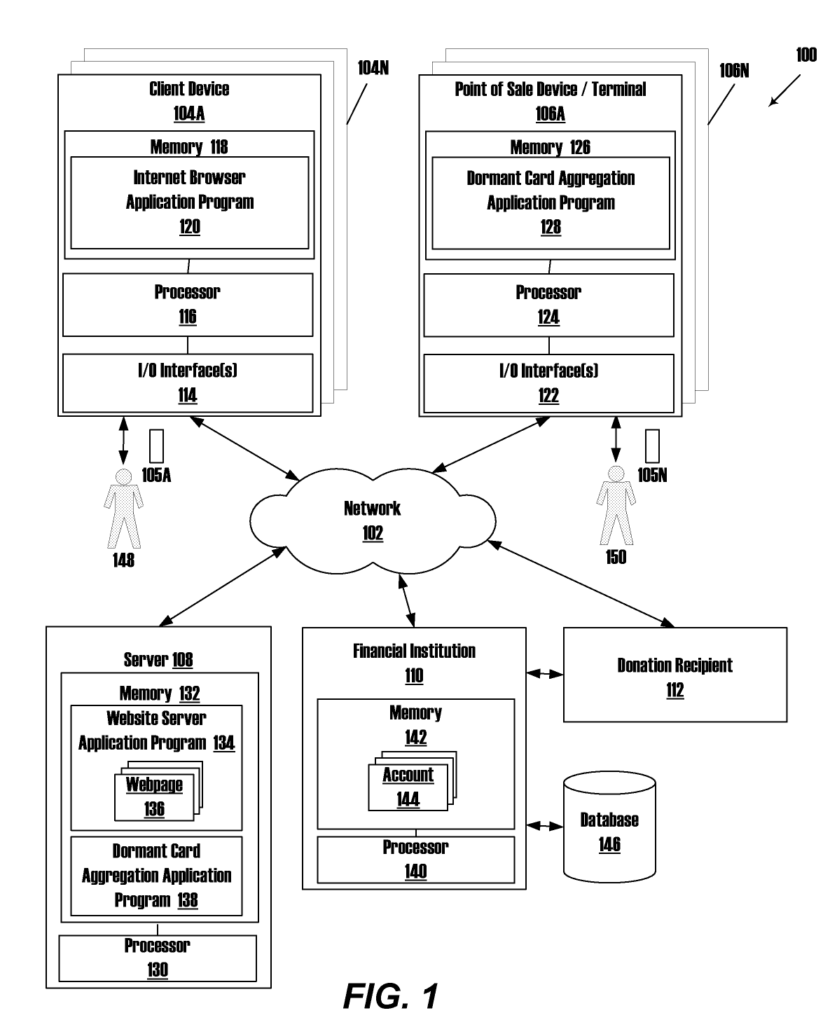

FIG. 1 illustrates an example environment and system in accordance with an embodiment of the invention. In this example, the environment can be a client-server configuration, and the system can be a dormant card aggregation system 100. The system 100 is shown with a communications network 102, such as the Internet, in communication with at least one client device 104A or point of sale device/terminal 106A. Any number of other client devices 104N or point of sale device/terminals 106N can also be in communication with the network 102. Each of the client devices 104A-N and point of sale device/terminals 106A-N can be operable to receive information from at least one prepaid card 105A-N. The network 102 is also shown in communication with at least one server 106A, such as a website host server. Any number of other servers or website host servers can also be in communication with the network 102. In addition, the network 102 is also shown in communication with at least one financial institution 108, such as a merchant bank or bank. Any number of other financial institutions, merchant banks, or banks can also be in communication with the network 102. Furthermore, the network 102 can also be in communication with at least one charitable entity 112. Any number of other charitable entities can be also be in communication with the network 102.

The communications network 102 shown in FIG. 1 can be, for example, the Internet. In another embodiment, the network 102 can be a wireless communications network capable of transmitting both voice and data signals, including image data signals or multimedia signals. Other types of communications networks, including local area networks (LAN), wide area networks (WAN), a public switched telephone network, or combinations thereof can be used in accordance with various embodiments of the invention.

Each client device 104A-N can be a computer or processor-based device capable of communicating with the communications network 102 via a signal, such as a wireless frequency signal or a direct wired communication signal. A respective communication or input/output interface 114 associated with each client device 104A-N can facilitate communications between the client device 104A-N and the network 102 or Internet. Each client device, such as 104A, can include a processor 116 and a computer-readable medium, such as a random access memory (RAM) 118, coupled to the processor 116. The processor 116 can execute computer-executable program instructions stored in memory 118. Computer executable program instructions stored in memory 118 can include an Internet browser application program, such as 120. The Internet browser application program 120 can be adapted to access and/or receive one or more webpages and associated content from at least one remotely located server, such as 108, or website host server.

Each point of sale device/terminal 106A-N can be a computer or processor-based device capable of communicating with the communications network 102 via a signal, such as a wireless frequency signal or a direct wired communication signal. A respective communication or input/output interface 122 associated with each point of sale device/terminal 106A-N can facilitate communications between the point of sale device/terminal 106A-N and the network 102 or Internet. Each point of sale device/terminal, such as 106A, can include a processor 124 and a computer-readable medium, such as a random access memory (RAM) 126, coupled to the processor 124. The processor 124 can execute computer-executable program instructions stored in memory 126. Computer executable program instructions stored in memory 126 can include a dormant card aggregation application program, or engine such as 128. The dormant card aggregation application program 128 can be adapted to access and/or receive data and associated content from the server 108 or website host server.

The server 108 can be a computer or processor-based device capable of communicating with the communications network 102 via a signal, such as a wireless frequency signal or a direct wired communication signal. Server 108, depicted as a single computer system, may be implemented as a network of computer processors. Examples of suitable servers are server devices, mainframe computers, networked computers, a processor-based device, and similar types of systems and devices. The server, such as 108, can include a processor 130 and a computer-readable medium, such as a random access memory (RAM) 132, coupled to the processor 130. The processor 130 can execute computer-executable program instructions stored in memory 132. Computer executable program instructions stored in memory 132 can include a website server application program, such as 134. The website server application program 134 can be adapted to transmit one or more webpages 136 and any associated content from the server 108. The computer executable program instructions stored in memory 132 can also include a dormant card aggregation application program or engine, such as 138. The dormant card aggregation application program 138 can be adapted to access and/or receive data and associated content from the server 108 or website host server.

The financial institution 110 can be a financial entity associated with a computer or processor-based device capable of communicating with the communications network 102 via a signal, such as a wireless frequency signal or a direct wired communication signal. In at least one embodiment, more than one financial institution can be in communication with communications network 102 to receive communications with other system components. The financial institution 110 can include or otherwise be associated with a processor 140 and a computer-readable medium, such as a random access memory (RAM) 142, coupled to the processor 140. Memory 142 can be configured to store one or more account files, such as an account 144, associated with one or more respective consumers. The processor 140 can execute computer-executable program instructions stored in memory 142. In one embodiment, computer executable program instructions stored in memory 142 can include a dormant card aggregation application program or engine, similar to 128 and 138. In the embodiment shown, a data storage device such as database 146 can be in communication with the financial institution 110. The database 146 shown can include additional account files, similar to account 144, associated with one or more consumers.

A donation recipient 112 can be an entity, such as a non-profit organization, associated with a computer or processor-based device capable of communicating with the communications network 102 via a signal, such as a wireless frequency signal or a direct wired communication signal. In at least one embodiment, more than one donation recipient can be in communication with communications network 102 to receive communications with other system components. In certain embodiments, a donation recipient 110 can include or otherwise be associated with a processor and a computer-readable medium, such as a random access memory (RAM), coupled to the processor. The processor can execute computer-executable program instructions stored in memory. In one embodiment, computer executable program instructions stored in memory can include a dormant card aggregation application program or engine, similar to 128 and 138.

The dormant card aggregation application program, such as 128 and 138, can be adapted to receive and/or collect various data from any number of client devices 104A-N, point of sale devices/terminals 106A-N, and servers 108 to process, edit, or otherwise modify one or more account files, such as an account 144, stored in memory 142 or in one or more associated data storage devices, such as database 146, and transfer monetary funds from any number of accounts 144 to one or more donation recipients 112 or accounts associated with respective donation recipients 112. In one embodiment, a dormant card aggregation application program can include computer code operable to determine an end of life associated with at least one of a plurality of prepaid cards, receive an indication to donate a portion of a respective monetary amount associated with the at least one of the plurality of prepaid cards, and facilitate transfer of monetary funds corresponding to any donated monetary amount to at least one account associated with at least one donation recipient. In another embodiment, a dormant card aggregation application program can include computer code operable to determining an end of life associated with each of a plurality of prepaid cards, receive a plurality of indications to donate a portion of respective monetary amounts associated with at least some of the plurality of prepaid cards, aggregate the respective donated monetary amounts, facilitate transfer of monetary funds corresponding to any donated monetary amounts to at least one account associated with at least one donation recipient, and transmit a notification to a consumer associated with at least one of the plurality of prepaid cards or to at least one donation recipient that a donation has been facilitated.

Generally, each of the memories 118, 126, 132, and 142, and data storage devices or databases 146 can store data and information for subsequent retrieval. In this manner, the system 100 can store various received or collected information in memory or a database associated with a client device, such as 104A; a point of sale device/terminal, such as 106A; a server, such as 108; a financial institution, such as 110. The memories 118, 126, 132, and 142, and data storage devices or databases 146 can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the database 146 shown can be integrated or distributed into any number of databases or data storage devices.

Suitable processors for a client device 104A-N, a point of sale device/terminal 106A-N, a server 108, and a financial institution 110 may comprise a microprocessor, an ASIC, and state machine. Example processors can be those provided by Intel Corporation and Motorola Corporation. Such processors comprise, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor, such as the processors 116, 124, 130, or 140, with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Client devices 104A-N may also comprise a number of other external or internal devices such as a mouse, a CD-ROM, DVD, a keyboard, a display, or other input or output devices. As shown in FIG. 1, a client device such as 104A can be in communication with an output device via a communication or input/output interface, such as 114. Examples of client devices 104A-N are personal computers, mobile computers, handheld portable computers, digital assistants, personal digital assistants, cellular phones, mobile phones, smart phones, pagers, digital tablets, desktop computers, laptop computers, Internet appliances, and other processor-based devices. In general, a client device, such as 104A, may be any type of processor-based platform that is connected to a network, such as 102, and that interacts with one or more application programs. Client devices 104A-N may operate on any operating system capable of supporting a browser or browser-enabled application including, but not limited to, Microsoft Windows®, Apple OSX™, and Linux. The client devices 104A-N shown include, for example, personal computers executing a browser application program such as Microsoft Corporation's Internet Explorer™, Netscape Communication Corporation's Netscape Navigator™, and Apple's Safari™, and Mozilla Firefox™.

In one embodiment, suitable client devices can be standard desktop personal computers with Intel x86 processor architecture, operating a Microsoft® Windows® operating system, and programmed using a Java language.

Prepaid cards 105A-N can include, but are not limited to, a gift card, a stored value card, any tangible medium, or an electronic or virtual-type instrument provided by a merchant, a retailer, a merchant bank, a financial institution, or any other type of entity. In one embodiment, a prepaid card can be a card with a predetermined monetary amount associated with the card. In another embodiment, a prepaid card can be an electronic certificate with a predetermined monetary amount associated with the certificate. Various combinations of different types of prepaid cards can be handled or otherwise processed by embodiments of the invention.

Point of sale devices/terminals 106A-N may also comprise a number of other external or internal devices such as a debit or credit card reader, a magnetic card reader, a RFID reader, a mouse, a CD-ROM, DVD, a keyboard, a display, or other input or output devices. As shown in FIG. 1, a point of sale device/terminal such as 106A can be in communication with an output device via a communication or input/output interface, such as 122. Examples of point of sale devices/terminals 106A-N are electronic cash registers, point of sale terminals, mobile computers, handheld portable computers, digital assistants, personal digital assistants, cellular phones, mobile phones, smart phones, pagers, digital tablets, desktop computers, laptop computers, Internet appliances, and other processor-based devices. In general, a point of sale device/terminal, such as 106A, may be any type of processor-based platform that is connected to a network, such as 102, and that interacts with one or more application programs or associated software. Point of sale devices/terminals 106A-N may operate on any operating system capable of supporting an application program including, but not limited to, Microsoft Windows®, Apple OSX™, and Linux. The point of sale devices/terminals 106A-N shown include, for example, a point of sale terminal executing a dormant card aggregation application program.

In one embodiment, a suitable point of sale device/terminal and associated software can include, but is not limited to, Aloha EDC Server, Datacap Systems Datatran, Datavantage Tradewind, EMN8 OrderM8, Exadigm Mate Plus, Hypercom T4100, IBM Websphere, Infogenesis Revelation, Ingenico Ingepay, Micros 3700, Oracle iPayment, Radiant Systems Epsilon, Southern Datacomm Protobase, and VeriFone Omni 3700.

A merchant, consumer, or user such as 148, can interact with a client device, such as 104A, via any number of input and output devices (not shown) such as an output display device, keyboard, and/or a mouse. In this manner, the merchant, consumer, or user 148 can access one or more webpages 136 located on a website server host, such as 106A, via an Internet browser application program, such as 120, operating on a client device, such as 104A. In the embodiment shown, a user 148 can input information associated with at least one prepaid card 105A via the client device 104A. The client device 104A can provide one or more options for the user 148 or otherwise permit the user 148 to manually input an indication to donate a monetary amount associated with the at least one prepaid card 105A. In addition, the client device 104A can provide one or more options for the user 148 or otherwise permit the user 148 to manually input a selection of at least one donation recipient to donate the monetary amount to. After the transaction has been processed by the system 100, the client device 104 can facilitate providing an output to the user 148, wherein the user 148 receives an output confirming a donation to the at least one donation recipient has been received. For example, an output can be an email, a printed receipt, a voice mail, an electronic message, or a facsimile.

In addition, a merchant, consumer, or user such as 150, can interact with a point of sale device/terminal, such as 106A, via any number of input and output devices (not shown) such as a debit or credit card reader, output display device, keyboard, and/or a mouse. In this manner, the merchant, consumer, or user 150 can access a dormant card aggregation application program located locally at the point of sale device/terminal, such as 106A, or on a server, such as 108. In the embodiment shown, a user 150 can input information associated with at least one prepaid card 105N via the point of sale device/terminal 106A. The point of sale device/terminal 106A can provide one or more options for the user 150 or otherwise permit the user 150 to manually input an indication to donate a monetary amount associated with the at least one prepaid card 105N. In addition, the point of sale device/terminal 106A can provide one or more options for the user 150 or otherwise permit the user 150 to manually input a selection of at least one donation recipient to donate the monetary amount to. After the transaction has been processed by the system 100, the point of sale device/terminal 106A can facilitate providing an output to the user 150, wherein the user 150 receives an output confirming a donation to the at least one donation recipient has been received. For example, an output can be an email, a printed receipt, a voice mail, an electronic message, or a facsimile.

Other system embodiments in accordance with the invention can include fewer or greater numbers of components and may incorporate some or all of the functionality described with respect to the system components shown in FIG. 1.

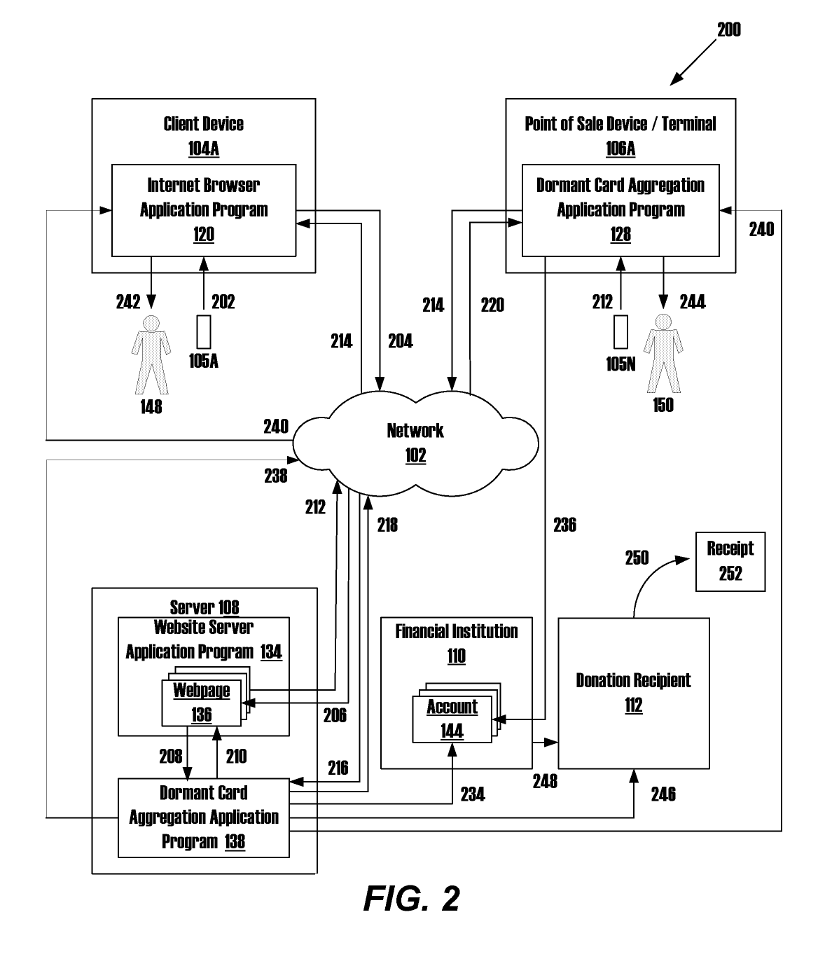

FIG. 2 illustrates an example data flow 200 between the components and entities shown associated with the example dormant card aggregation system 100 of FIG. 1 for electronically aggregating and donating monetary amounts associated with dormant gift cards in accordance with an example embodiment of the invention. As shown in FIG. 2, a user such as 148 can input 202 or otherwise enter a card identifier or other information associated with a prepaid card 105A, at a client device, such as 104A. In the embodiment shown, a webpage such as 136 can be accessed by the user 148 operating the client device 104A via a network, such as 102, and an Internet browser application program, such as 120. The user 148 can, for example, input the card identifier or other information in the webpage 136 using an input/output device, such as a keyboard or card reader, associated with the client device 104A. The client device 104A can transmit 204 via the network 102 a signal corresponding to the card identifier or other information, and the network 102 can transmit 206 the signal to the webpage 136 hosted by a website server application program, such as 134, hosted by a server, such as 108. The website server application program 134 can, via the webpage 136, transmit 208 the card identifier or other information to a dormant card aggregation application program, such as 138, for processing. The dormant card aggregation application program 138 can receive the card identifier or other information, determine whether a monetary amount remains on the prepaid card, and further determine an end of life associated with the card identifier or prepaid card. The dormant card aggregation application program 138 can determine one or more selectable user options based at least in part on the end of life determination. For example, a selectable user option can be an option to donate some or all of a remaining monetary amount to a particular donation recipient, such as a charitable organization. A signal associated with the end of life associated with the card identifier can be transmitted 210 or otherwise returned to the website server application program 134 for displaying via the webpage 136. In addition to the end of life information, the website server application program 134 can transmit 212 other information such as the selectable user options via the network 102, and the network 102 can provide 214 the end of life information and selectable user options to the Internet browser application program 120 for viewing by the user 148 at client device 104A.

In response to the received information, the user 148 can transmit instructions or selected options to the dormant card aggregation application program 138. Using a similar data transmission path as described above, the user can input 202 the instructions or selected options via the Internet browser application program 120 executing on the client device 104A. The Internet browser application program 120 can transmit 204 the instructions or selected options to the server 108 via the network 102. The network transmits 206 the instructions or selected options to the webpage 136 and website server application program 134. The webpage 136 and website server application program 134 can transmit 208 the instructions or selected options to the dormant card aggregation application program 138 for further processing described below.

Similar interactions between a user 150, a point of sale device/terminal such as 106A, and a server 108 can be facilitated by embodiments of the invention. For example, a user 150 can input 212 or otherwise enter a card identifier or other information associated with a prepaid card, such as 105N, at a point of sale device/terminal, such as 106A. In the embodiment shown, a dormant card aggregation application program 128 and associated user interface can be accessed by the user 150 operating the point of sale device/terminal 106A. The user 150 can, for example, input 212 the card identifier or other information in the dormant card aggregation application program 128 and associated user interface using an input/output device, such as a keyboard or card reader, associated with the point of sale device/terminal 106A. In the embodiment shown in FIG. 2, the dormant card aggregation application program 128 and/or point of sale device/terminal 106A can transmit 214 via the network 102 a signal corresponding to the card identifier or other information, and the network 102 can transmit 216 the signal directly to the dormant card aggregation application program 138 hosted by the server 108 for processing. In another embodiment, the dormant card aggregation application program 128 executing on the point of sale device/terminal 106A can process the input 212 from the user 150. In either embodiment, a dormant card aggregation application program, 128 or 138, can receive the card identifier or other information, determine whether a monetary amount remains on the prepaid card, and further determine an end of life associated with the card identifier or prepaid card. The dormant card aggregation application program, 128 or 138, can determine one or more selectable user options based at least in part on the end of life determination. For example, a selectable user option can be an option to donate some or all of a remaining monetary amount to a particular donation recipient, such as a charitable organization. In the embodiment shown in FIG. 2, a signal associated with the end of life associated with the card identifier can be transmitted 218 or otherwise returned to the network 102, and transmitted 220 to the point of sale device/terminal 106A and dormant aggregation application program 128 for displaying via the associated user interface. In addition to the end of life information, the dormant aggregation application program 138 can transmit 218 other information such as the selectable user options via the network 102, and the network 102 can provide or otherwise transmit 220 the end of life information and selectable user options to the point of sale device/terminal 106A, dormant aggregation application program 128, and associated user interface for viewing by the user 150 via the point of sale device/terminal 106A.

In response to the received information, the user 150 can transmit instructions or selected options to the dormant card aggregation application program, 128 or 138. Using a similar data transmission path as described above, the user can input 212 the instructions or selected options via the point of sale device/terminal 106A, dormant aggregation application program 128 and/or associated user interface. As shown in the embodiment of FIG. 2, the point of sale device/terminal 106A can transmit 214 the instructions or selected options to the server 108 via the network 102. The network transmits 216 the instructions or selected options to the dormant aggregation application program 138. The dormant aggregation application program 138 can transmit 218 the instructions or selected options to the network 102, and the network can transmit the instructions or selected options to the point of sale device/terminal 106A and dormant card aggregation application program 128, and associated user interface for viewing by the user 150. In another embodiment, the dormant card aggregation application program 128 executing on the point of sale device/terminal 106A can process the input 212 from the user 150.

For any of the above embodiments, after a user, 148 or 150, has submitted instructions or selected options to a dormant aggregation application program, 128 or 138, the dormant aggregation application program, 128 or 138, can implement the instructions or selected options by communicating 234, 236 with at least one financial institution. For example, in one embodiment, a dormant aggregation application program 128 hosted by a server 108 can receive instructions or selected options from a user 148 operating a client device 104A. The dormant aggregation application program 128 can implement some or all of the instructions or selected options by transmitting 234 corresponding instructions to a financial institution 110. In this example, the corresponding instructions may be to add or otherwise transfer a predefined monetary amount from the prepaid card 105A to an account, such as 144, associated with a donation recipient, such as 112. In another embodiment, a dormant aggregation application program 128 hosted by a point of sale device/terminal 106A can receive instructions or selected options from a user 150. The dormant aggregation application program 128 can implement some or all of the instructions or selected options by transmitting 236 corresponding instructions to a financial institution 110. In this example, the corresponding instructions may be to add or otherwise transfer a predefined monetary amount from the prepaid card 105N to an account, such as 144, associated with a donation recipient, such as 112. For either example, the financial institution 110 can facilitate adding or transferring the predefined monetary amount to the account 144 associated with a donation recipient 112. In some instances, instructions or selected options can include instructions to add or otherwise transfer multiple or aggregated monetary amounts to respective multiple accounts associated with one or more donation recipients, such as 112.

In the embodiment shown in FIG. 2, each dormant aggregation application program, 128 or 138, can process inputs from multiple users operating any number of client devices 104AN and/or point of sale devices/terminals 106A. When instructions are received by the dormant aggregation application program, 128 or 138, to add or otherwise transfer monetary amounts from any number of prepaid cards 105A-N, the dormant aggregation application program, 128 or 138, can aggregate the monetary amounts for any number of designated donation recipients, such as 112, and transmit 234, 236 corresponding instructions to the financial institution 112 to add or otherwise transfer the aggregated monetary amounts from certain prepaid cards to a respective account, such as 144, associated with the designated donation recipient, such as 112. In this manner, the dormant aggregation application programs, 128 and 138, can facilitate aggregating and donating monetary amounts associated with dormant prepaid cards.

As shown in FIG. 2, after a monetary amount has been added to or otherwise transferred to an account, such as 144, on behalf of a particular user, such as 148, the dormant aggregation application program 138 hosted by the server 108 can generate and transmit 238 a communication indicating that a donation has been made to a particular entity, such as the donation recipient 112. The network 102 receives the communication, and transmits 240 the communication to a client device, such as 104A, or another client device associated with the user 148. The client device 104A can output 242 the communication via a printing device or associated user interface, or further transmit or otherwise facilitate transmission of the communication to another client device associated with the user 150. The communication can be an email, text message, receipt, tax receipt, or other message documenting the donation of a certain monetary amount from the user 148 to the donation recipient 112. Likewise, after a monetary amount has been added to or otherwise transferred to an account, such as 144, on behalf of a particular user, such as 150, the dormant aggregation application program 128 executing on the point of sale device/terminal, such as 106A, can generate and transmit 244 a communication indicating that a donation has been made to a particular entity, such as the donation recipient 112. The point of sale device/terminal 106 can output the communication via a printing device or associated user interface, or further transmit or otherwise facilitate transmission of the communication to a client device associated with the user 150. The communication can be an email, text message, receipt, tax receipt, or other message documenting the donation of a certain monetary amount from the user 150 to the donation recipient 112. In either of the instances described above, a communication could be output by a dormant aggregation application program, such as 128 or 138, and sent to the user 148, 150 by regular postal mail.

In one embodiment, a communication to a user, such as 148 or 150, can be generated and transmitted by a financial institution, such as 110, and/or a donation recipient, such as 112. In such embodiments, the communication can be an email, text message, receipt, tax receipt, or other message documenting the donation of a certain monetary amount from the user 148, 150 to the donation recipient 112. The communication can be output via a printing device or user interface associated with a client device, such as 104A, or point of sale device/terminal, such as 106A, or otherwise transmitted to another client device associated with the user 148, 150. In some instances, such a communication can be output by the financial institution, such as 110, and/or a donation recipient, such as 112, and sent to the user 148, 150 by regular postal mail.

Also shown in FIG. 2, a communication can be sent to the donation recipient 112 that a donation has been made. The communication can be transmitted 246 by a dormant card aggregation application program, such as 128 or 138, or may be transmitted 248 by the financial institution 110 to the donation recipient 112. In any instance, in certain embodiments, the donation recipient 112 may generate and transmit 250 an output or communication 252 to a dormant card aggregation application program, such as 128 or 138, a client device 104A-N, a point of sale device/terminal 106A-N, or users 148, 150, acknowledging receipt of any donated monetary amounts. Similar to those described above, the output or communication 252 can be an email, text message, receipt, tax receipt, or other message documenting the donation of a certain monetary amount from the user 148, 150 to the donation recipient 112.

One skilled in the art may recognize the applicability of embodiments of the invention to other environments, contexts, and applications. One will appreciate that components of the system 100 and data flow 200 shown in and described with respect to FIGS. 1 and 2 are provided by way of example only. Numerous other operating environments, system architectures, and device configurations are possible. Accordingly, embodiments of the invention should not be construed as being limited to any particular operating environment, system architecture, or device configuration.

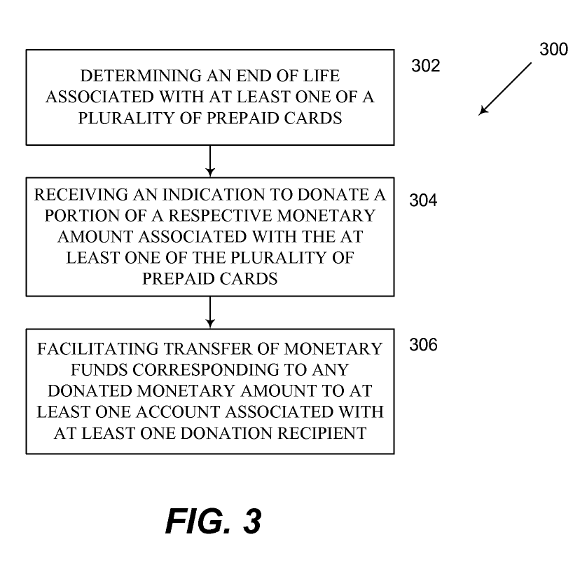

Embodiments of a system, such as 100, and data flow, such as 200, can facilitate donating a monetary amount associated with a dormant prepaid card. Improvements in dormant prepaid card accounting and management, as well as new sources of donation revenue, can be achieved by way of implementation of various embodiments of the system 100, data flow 200, and methods described herein. Example methods and processes which can be implemented with the example system 100 and data flow 200, as well as other system and data flow embodiments, are described by reference to FIGS. 3-5.

FIG. 3 illustrates an example method of donating a monetary amount associated with a dormant prepaid card, according to one embodiment of the invention. The method 300 begins at block 302, in which an end of life associated with at least one of a plurality of prepaid cards is determined.

In one aspect of one embodiment, determining an end of life associated with at least one of a plurality of prepaid cards can include determining whether a predefined date has been met or has past, determining that the prepaid card was activated at a certain time, or determining that the prepaid card was last used at a certain time.

Block 302 is followed by block 304, in which an indication is received to donate a portion of a respective monetary amount associated with the at least one of the plurality of prepaid cards.

In one aspect of one embodiment, an indication can include receiving an instruction from a consumer via a network, receiving an instruction from a consumer via a website, receiving an instruction from a consumer via a point of sale device, or receiving an instruction from a consumer via a point of sale terminal.

Block 304 is followed by block 306, in which transfer of monetary funds corresponding to any donated monetary amount to at least one account associated with at least one donation recipient is facilitated.

In one aspect of one embodiment, facilitating transfer of monetary funds corresponding to the donated monetary amount to an account associated with a donation recipient can include aggregating a plurality of donated monetary amounts.

After block 306, the method 300 ends.

In one aspect of one embodiment, the method 300 can include receiving a plurality of indications to donate a portion of respective monetary amounts associated with the plurality of prepaid cards; and aggregating a plurality of donated monetary amounts.

In one aspect of one embodiment, the method 300 can include receiving a plurality of respective account numbers associated with respective prepaid cards.

In one aspect of one embodiment, the method 300 can include outputting a selectable option for a consumer to provide an indication to donate a portion of a respective monetary amount associated with the at least one of the plurality of prepaid cards.

In one aspect of one embodiment, the method 300 can include retrieving a previously stored preference associated with a consumer, wherein the preference is associated with a consumer's desire to donate a monetary amount associated with at least one prepaid card.

In one aspect of one embodiment, the method 300 can include transmitting a notification to a consumer associated with the at least one of the plurality of prepaid cards or to the at least one donation recipient that a donation has been facilitated.

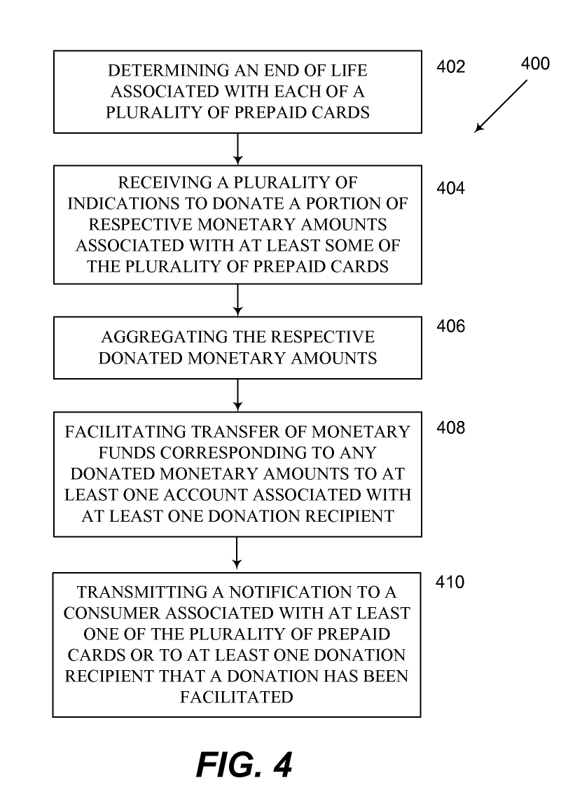

FIG. 4 illustrates another example method of donating a monetary amount associated with a plurality of dormant prepaid cards, according to one embodiment of the invention.

This example method 400 begins at block 402, in which an end of life associated with each of a plurality of prepaid cards is determined.

Block 402 is followed by block 404, in which a plurality of indications to donate a portion of respective monetary amounts associated with at least some of the plurality of prepaid cards is received.

In one aspect of one embodiment, at least one of the plurality of indications can include receiving a previously stored preference associated with a consumer, wherein the preference is associated with a consumer's desire to donate a monetary amount associated with at least one prepaid card; receiving an instruction from a consumer via a network; receiving an instruction from a consumer via a website; receiving an instruction from a consumer via a point of sale device; or receiving an instruction from a consumer via a point of sale terminal.

Block 404 is followed by block 406, in which the respective donated monetary amounts are aggregated.

Block 406 is followed by block 408, in which transfer of monetary funds corresponding to any donated monetary amounts to at least one account associated with at least one donation recipient is facilitated.

Block 408 is followed by block 410, in which a notification is transmitted to a consumer associated with at least one of the plurality of prepaid cards or to at least one donation recipient that a donation has been facilitated.

After block 410, the method 400 ends.

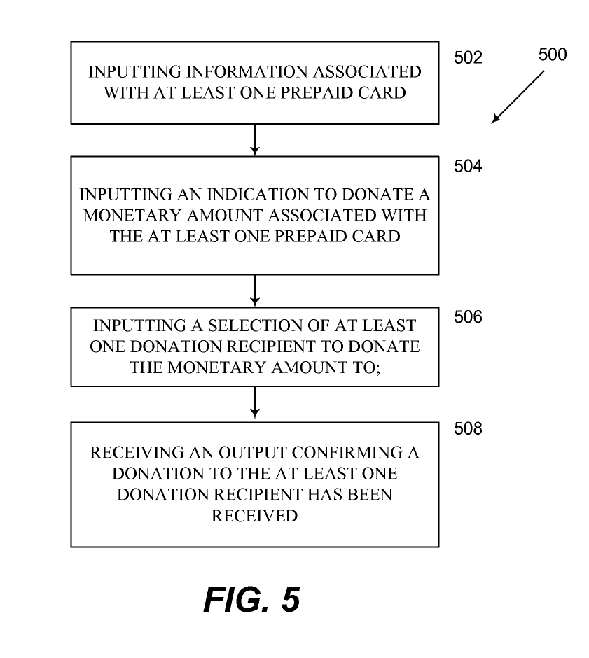

FIG. 5 illustrates an example method of donating a monetary amount associated with a dormant prepaid card, according to one embodiment of the invention.

The method 500 begins at block 502, wherein information associated with at least one prepaid card is input.

In at least one aspect of one embodiment, the information comprises at least one prepaid card number.

In at least one aspect of one embodiment, the information is input via at least one of a network, a website, a point of sale device, or a point of sale terminal.

Block 502 is followed by block 504, in which an indication to donate a monetary amount associated with the at least one prepaid card is input.

In at least one aspect of one embodiment, the indication is input via at least one of a network, a website, a point of sale device, or a point of sale terminal.

Block 504 is followed by block 506, in which a selection of at least one donation recipient to donate the monetary amount to is input.

Block 506 is followed by block 508, in which an output is received confirming a donation to the at least one donation recipient has been received.

In at least one aspect of one embodiment, the output comprises at least one of an email, a printed receipt, a voice mail, an electronic message, or a facsimile.

The method 500 ends at block 508.

In at least one aspect of one embodiment, the method 500 can further comprise inputting at least one preference to donate any dormant monetary amount associated with the at least one prepaid card.

Embodiments of the invention are described above with reference to block diagrams and flowchart illustrations of systems, methods, apparatuses and computer program products. It will be understood that some or all of the blocks of the block diagrams and flowchart illustrations, and combinations of blocks in the block diagrams and flowchart illustrations, respectively, can be implemented by computer program instructions. These computer program instructions may be loaded onto a general purpose computer, special purpose computer such as a switch, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data-processing apparatus to cause a series of operational elements or steps to be performed on the computer or other programmable apparatus to produce a computer-implemented process such that the instructions that execute on the computer or other programmable apparatus provide elements or steps for implementing the functions specified in the flowchart block or blocks.

Accordingly, blocks of the block diagrams and flowchart illustrations may support combinations of means for performing the specified functions, combinations of elements or steps for performing the specified functions, and program instruction means for performing the specified functions. It will also be understood that some or all of the blocks of the block diagrams and flowchart illustrations, and combinations of blocks in the block diagrams and flowchart illustrations, can be implemented by special purpose hardware-based computer systems that perform the specified functions, elements or steps, or combinations of special purpose hardware and computer instructions.

Additionally, it is to be recognized that, while the invention has been described above in terms of one or more preferred embodiments, it is not limited thereto. Various features and aspects of the above described invention may be used individually or jointly. Although the invention has been described in the context of its implementation in a particular environment and for particular purposes, its usefulness is not limited thereto and the invention can be beneficially utilized in any number of environments and implementations. Furthermore, while the methods have been described as occurring in a specific sequence, it is appreciated that the order of performing the methods is not limited to that illustrated and described herein, and that not every step described and illustrated need be performed. Accordingly, the claims set forth below should be construed in view of the full breadth and spirit of the invention as disclosed herein.

The claimed invention is:

1. A method of donating a monetary amount associated with a dormant prepaid card, comprising:
determining an end of life associated with at least one of a plurality of prepaid cards;
receiving an indication to donate a portion of a respective monetary amount associated with the at least one of the plurality of prepaid cards; and
facilitating transfer of monetary funds corresponding to any donated monetary amount to at least one account associated with at least one donation recipient.

2. The method of claim 1, further comprising:
receiving a plurality of indications to donate a portion of respective monetary amounts associated with the plurality of prepaid cards; and
aggregating a plurality of donated monetary amounts.

3. The method of claim 1, wherein determining an end of life associated with at least one of a plurality of prepaid cards comprises determining whether a predefined date has been met or has past, determining that the prepaid card was activated at a certain time, or determining that the prepaid card was last used at a certain time.

4. The method of claim 1, wherein the indication comprises: receiving an instruction from a consumer via a network, receiving an instruction from a consumer via a website, receiving an instruction from a consumer via a point of sale device, or receiving an instruction from a consumer via a point of sale terminal.

5. The method of claim 1, further comprising:
receiving a plurality of respective account numbers associated with respective prepaid cards.

6. The method of claim 1, wherein facilitating transfer of monetary funds corresponding to the donated monetary amount to an account associated with a donation recipient comprises aggregating a plurality of donated monetary amounts.

7. The method of claim 1, further comprising:
outputting a selectable option for a consumer to provide an indication to donate a portion of a respective monetary amount associated with the at least one of the plurality of prepaid cards.

8. The method of claim 1, further comprising:
retrieving a previously stored preference associated with a consumer, wherein the preference is associated with a consumer's desire to donate a monetary amount associated with at least one prepaid card.

9. The method of claim 1, further comprising:
transmitting a notification to a consumer associated with the at least one of the plurality of prepaid cards or to the at least one donation recipient that a donation has been facilitated.

10. A system for donating a monetary amount associated with a dormant prepaid card, comprising:
a processor comprising a computer-readable medium with a set of instructions operable to:
determine an end of life associated with at least one of a plurality of prepaid cards;
receive an indication to donate a portion of a respective monetary amount associated with the at least one of the plurality of prepaid cards;
facilitate transfer of monetary funds corresponding to any donated monetary amount to at least one account associated with at least one donation recipient.

11. The system of claim 10, wherein the processor further comprises instructions operable to:
receive a plurality of indications to donate a portion of respective monetary amounts associated with the plurality of prepaid cards; and
aggregate a plurality of donated monetary amounts.

12. The system of claim 10, wherein determining an end of life associated with at least one of a plurality of prepaid cards comprises determining whether a predefined date has been met or has past, determining that the prepaid card was activated at a certain time, or determining that the prepaid card was last used at a certain time.

13. The system of claim 10, wherein the indication comprises: receiving an instruction from a consumer via a network, receiving an instruction from a consumer via a website, receiving an instruction from a consumer via a point of sale device, or receiving an instruction from a consumer via a point of sale terminal.

14. The system of claim 10, wherein the processor further comprises instructions operable to:
receive a plurality of respective account numbers associated with respective prepaid cards.

15. The system of claim 10, wherein the instructions operable to facilitate transfer of monetary funds corresponding to the donated monetary amount to an account associated with a donation recipient comprise instructions to aggregate a plurality of donated monetary amounts.

16. The system of claim 10, wherein the processor further comprises instructions operable to:
output a selectable option for a consumer to provide an indication to donate a portion of a respective monetary amount associated with the at least one of the plurality of prepaid cards.

17. The system of claim 10, wherein the processor further comprises instructions operable to:
retrieve a previously stored preference associated with a consumer, wherein the preference is associated with a consumer's desire to donate a monetary amount associated with at least one prepaid card.

18. The system of claim 10, wherein the processor further comprises instructions operable to:
transmit a notification to a consumer associated with the at least one of the plurality of prepaid cards or to the at least one donation recipient that a donation has been facilitated.

19. A method of donating a monetary amount associated with a plurality of dormant prepaid cards, comprising:
determining an end of life associated with each of a plurality of prepaid cards;
receiving a plurality of indications to donate a portion of respective monetary amounts associated with at least some of the plurality of prepaid cards;
aggregating the respective donated monetary amounts;
facilitating transfer of monetary funds corresponding to any donated monetary amounts to at least one account associated with at least one donation recipient; and
transmitting a notification to a consumer associated with at least one of the plurality of prepaid cards or to at least one donation recipient that a donation has been facilitated.

20. The method of claim 19, wherein at least one of the plurality of indications comprises: receiving a previously stored preference associated with a consumer, wherein the preference is associated with a consumer's desire to donate a monetary amount associated with at least one prepaid card; receiving an instruction from a consumer via a network; receiving an instruction from a consumer via a website; receiving an instruction from a consumer via a point of sale device; or receiving an instruction from a consumer via a point of sale terminal.

21. A method of donating a monetary amount associated with a dormant prepaid card, comprising:
inputting information associated with at least one prepaid card;
inputting an indication to donate a monetary amount associated with the at least one prepaid card;
inputting a selection of at least one donation recipient to donate the monetary amount to; and
receiving an output confirming a donation to the at least one donation recipient has been received.

22. The method of claim 21, wherein the information comprises at least one prepaid card number.

23. The method of claim 21, wherein the information is input via at least one of a network, a website, a point of sale device, or a point of sale terminal.

24. The method of claim 21, wherein the indication is input via at least one of a network, a website, a point of sale device, or a point of sale terminal.

25. The method of claim 21, further comprising:
inputting at least one preference to donate any dormant monetary amount associated with the at least one prepaid card.

26. The method of claim 21, wherein the output comprises at least one of: an email, a printed receipt, a voice mail, an electronic message, or a facsimile.
